(19) United States
(12) Patent Application Publication
(10) Pub. No.: US 2026/0360649 A1
(43) Pub. Date: Nov. 12, 2026

(54) RELAY

(71) Applicant: Xiamen Hongfa Electric Power Controls Co., Ltd., Xiamen, Fujian (CN)

(72) Inventors: Meng WANG, Xiamen, Fujian (CN); Wenguang DAI, Xiamen, Fujian (CN); Songsheng CHEN, Xiamen, Fujian (CN)

(21) Appl. No.: 19/120,817

(22) PCT Filed: Oct. 11, 2023
(86) PCT No.: PCT/CN2023/124059

§ 371 Date: Apr. 14, 2025

(30) Foreign Application Priority Data
Oct. 12, 2022 (CN) 202211249316.5

(51) Int. Cl. H01H 50/54; H01H 50/02

(52) U.S. Cl. CPC H01H 50/54; H01H 50/02

(57) ABSTRACT

A relay includes a contact container having a contact chamber; a pair of static contact leading-out terminals fixedly disposed relative to the contact container; a first magnetizer provided in the contact chamber and fixedly disposed relative to the contact container; a push rod assembly including a push rod movable relative to the contact container and a second magnetizer disposed at an end of the push rod and offset from the first magnetizer; and a movable contact assembly movable relative to the push rod assembly between a first and second positions. Wherein the movable contact assembly includes a movable contact piece and a third magnetizer. The first and second magnetizers, and the third magnetizer are respectively disposed at two opposite sides of the movable contact piece. The third and the first magnetizers form a first magnetic circuit, and the third and the second magnetizers form a second magnetic circuit.

### CROSS-REFERENCE

The present disclosure is the U.S. national phase application of International Application No. PCT/CN2023/124059, filed on Oct. 11, 2023, which claims priority to Chinese Patent Application No. 202211249316.5, filed on Oct. 12, 2022 and titled “Relay”, the entire content of which is incorporated herein by reference in its entirety.

### TECHNICAL FIELD

The present disclosure relates to a relay.

### BACKGROUND

A relay is an electronic control device that has a control system (also known as an input circuit) and a controlled system (also known as an output circuit) and is typically used in an automatic control circuit. The relay is actually an “automatic switch” that uses a smaller current to control a larger current. Thus, the relay plays a role in automatic regulation, safety protection, and circuit switching and so on.

A high-voltage direct-current relay is one kind of relays, and in order to solve a problem that contacts of the high-voltage direct-current relay pop open due to an electro-dynamic repulsion force generated by a short-circuit current, an electromagnetic structure with an anti-short circuit ring is usually provided in the related art, and based on a position of an upper yoke, it may be further divided into a follower structure and a fixed structure. Specifically, the follower structure refers to that the upper yoke is on a movable assembly of the relay, while the fixed structure refers to that the upper yoke is at a fixed position other than the movable assembly. However, although the fixed anti-short circuit structure greatly enhances its anti-short circuit ability, a breaking ability is weakened due to a negative correlation between the anti-short circuit ability and the breaking ability. Additionally, the follower anti-short circuit structure is affected by a retaining force for a movable iron core; when the short-circuit current is high, the iron core will be disengaged, causing the contacts to pop open; if the retaining force for the movable iron core is increased, a coil needs to be enlarged, which goes against small volume and lightweight designs.

### SUMMARY

According to an aspect of the present disclosure, a relay according to embodiments of the present disclosure includes a contact container, a pair of static contact leading-out terminals, a first magnetizer, a push rod assembly, and a movable contact assembly. The contact container has a contact chamber. The pair of static contact leading-out terminals are fixedly disposed relative to the contact container. The first magnetizer is disposed in the contact chamber and fixedly disposed relative to the contact container. The push rod assembly includes a push rod and a second magnetizer, the push rod is movable along an axial direction of the push rod relative to the contact container, and the second magnetizer is disposed at an end of the push rod and offset from the first magnetizer in the axial direction of the push rod. The movable contact assembly is movable relative to the push rod assembly along the axial direction of the push rod and between a first position close to the static contact leading-out terminal and a second position away from the static contact leading-out terminal. The movable contact assembly includes a movable contact piece and a third magnetizer; the first magnetizer and the second magnetizer are disposed at a side of the movable contact piece facing the static contact leading-out terminal; along the axial direction of the push rod, the third magnetizer is fixedly disposed at a side of the movable contact piece facing away from the first magnetizer and the second magnetizer; the third magnetizer and the first magnetizer are configured to form a first magnetic circuit, and the third magnetizer and the second magnetizer are configured to form a second magnetic circuit.

According to an embodiment of the present disclosure, wherein the pair of static contact terminals are connected to the contact container, at least a portion of each of the static contact terminals is located within the contact chamber.

According to an embodiment of the present disclosure, the relay further includes an elastic member connecting to the movable contact assembly and the push rod assembly and configured to apply an elastic force to the movable contact assembly to move towards the first position.

According to an embodiment of the present disclosure, in a state where the movable contact assembly is in the first position, a magnetic gap between the first magnetizer and the third magnetizer is greater than a magnetic gap between the second magnetizer and the third magnetizer.

According to an embodiment of the present disclosure, when the movable contact assembly is in the first position, the second magnetizer is in direct contact with the third magnetizer.

According to an embodiment of the present disclosure, the pushing push rod assembly further includes: a support seat fixedly disposed at an end of the push rod along the axial direction and at least partially extending into the contact chamber; the second magnetizer is fixedly connected to the support seat, and the elastic member is disposed between the movable contact assembly and the support seat.

According to an embodiment of the present disclosure, the support seat includes: a base connected to an end of the push rod, the elastic member is disposed between the base and the movable contact assembly; and a bracket connected to the base, the second magnetizer is connected to an inner wall surface of the bracket, and the movable contact piece and the third magnetizer are movably disposed in a space enclosed by the base and the bracket.

According to an embodiment of the present disclosure, the bracket includes: a top portion, the second magnetizer is connected to an inner wall surface of the top portion; and two lateral portions connected to both sides of the top portion respectively, wherein an end, away from the top portion, of each of the two lateral portions is connected to the base; and the two lateral portions, the top portion and the base together form a space for movement of the movable contact assembly.

According to an embodiment of the present disclosure, the first magnetizer has a perforation that runs through two opposite sides of the first magnetizer along the axial direction of the push rod, and a position of the second magnetizer corresponds to the perforation along the axial direction of the push rod.

According to an embodiment of the present disclosure, the second magnetizer includes a first magnetizer piece and a second magnetizer piece; the first magnetizer piece and the second magnetizer piece are disposed side by side along a length direction of the movable contact piece and are respectively located at two opposite sides of the first magnetizer.

According to an embodiment of the present disclosure, the contact container further has a pair of first through-holes and a second through-hole, the first through-holes and the second through-hole is in communication with the contact chamber, and a pair of static contact leading-out terminals pass through the pair of first through-holes in one-to-one correspondence; the relay further includes a connector passing through the second through-hole, the connector includes a first end and a second end, the first end is connected to the contact container, and the second end is connected to the first magnetizer.

According to an embodiment of the present disclosure, the contact container includes: a yoke plate; and an insulating cover, including a top wall and a side wall, wherein one end of the side wall is connected to a periphery of the top wall, while another end of the side wall is connected to the yoke plate. The first through-holes and the second through-hole are opened in the top wall, and the first end of the connector is connected to an outer wall surface of the top wall.

According to an embodiment of the present disclosure, the insulating cover includes a ceramic cover and a frame, the ceramic cover includes the top wall and the side wall, and another end of the side wall is connected to the yoke plate through the frame; in the outer wall surface of the top wall, a first metallization layer is provided at a periphery of the first through-hole, and a second metallization layer is provided at a periphery of the second through-hole; the static contact leading-out terminal is welded to the top wall through the first metallization layer, and the first end of the connector is welded to the top wall through the second metallization layer.

According to an embodiment of the present disclosure, the top wall and the side wall are of an integral structure; or the top wall and the side wall are of a separate structure and connected by welding.

According to an embodiment of the present disclosure, the first magnetizer is spaced apart from an inner wall surface of the top wall.

According to an embodiment of the present disclosure, the first magnetizer has a connecting hole, and the connector passes through the connecting hole.

According to an embodiment of the present disclosure, the contact container includes: a yoke plate; and an insulating cover connected to the yoke plate. The relay further includes a fixed frame disposed in the contact chamber and fixedly connected to the yoke plate, the first magnetizer is fixedly connected to the fixed frame.

### BRIEF DESCRIPTION OF THE DRAWINGS

The above and other features and advantages of the present disclosure will become more apparent by describing in detail exemplary embodiments with reference to the accompanying drawings.

FIG. 1 shows a schematic perspective view of a relay according to a first embodiment of the present disclosure.

FIG. 2 shows a schematic view of FIG. 1 with a ceramic cover and a frame removed.

FIG. 3 shows a schematic top view of FIG. 1.

FIG. 4 shows a sectional view along line A-A in FIG. 3.

FIG. 5 shows a schematic exploded view of FIG. 1.

FIG. 6 shows a sectional view along line B-B in FIG. 3, where a ceramic cover, a frame, and a connector are omitted and an overtravel has been completed.

FIG. 7 shows a sectional view along line C-C in FIG. 3, where a ceramic cover, a frame, and a connector are omitted and an overtravel has been completed.

FIG. 8 shows a sectional view along line A-A in FIG. 3, where a ceramic cover, a frame, and a connector are omitted and an overtravel has been completed.

FIG. 9 shows a sectional view along line B-B in FIG. 3, where a ceramic cover, a frame, and a connector are omitted, and a movable contact piece just comes into contact with or separates from a static contact leading-out terminal.

FIG. 10 shows a sectional view along line C-C in FIG. 3, where a ceramic cover, a frame, and a connector are omitted, and a movable contact piece just comes into contact with or separates from a static contact leading-out terminal.

FIG. 11 shows a sectional view along line A-A in FIG. 3, where a ceramic cover, a frame, and a connector are omitted, and a movable contact piece just comes into contact with or separates from a static contact leading-out terminal.

FIG. 12 shows a schematic top view of a relay according to a second embodiment of the present disclosure.

FIG. 13 shows a schematic view of FIG. 12 with a ceramic cover and a frame removed.

FIG. 14 shows a sectional view along line D-D in FIG. 12.

FIG. 15 shows a schematic exploded view of FIG. 12.

FIG. 16 shows a sectional view along line E-E in FIG. 12, where a ceramic cover, a frame, and a connector are omitted and an overtravel has been completed.

FIG. 17 shows a sectional view along line F-F in FIG. 12, where a ceramic cover, a frame, and a connector are omitted and an overtravel has been completed.

FIG. 18 shows a sectional view along line D-D in FIG. 12, where a ceramic cover, a frame, and a connector are omitted and an overtravel has been completed.

FIG. 19 shows a sectional view along line E-E in FIG. 12, where a ceramic cover, a frame, and a connector are omitted, and a movable contact piece just comes into contact with or separates from a static contact leading-out terminal.

FIG. 20 shows a sectional view along line F-F in FIG. 12, where a ceramic cover, a frame, and a connector are omitted, and a movable contact piece just comes into contact with or separates from a static contact leading-out terminal.

FIG. 21 shows a sectional view along line D-D in FIG. 12, where a ceramic cover, a frame, and a connector are omitted, and a movable contact piece just comes into contact with or separates from a static contact leading-out terminal.

FIG. 22 shows a schematic exploded view of a relay according to embodiments of the present disclosure.

### REFERENCE NUMERALS

10. contact container; 101. contact chamber; 102. first through-hole; 103. second through-hole; 11a. insulating cover; 11. ceramic cover; 111. top wall; 112. side wall; 113. first metallization layer; 114. second metallization layer; 12. frame; 13. yoke plate; 131. third through-hole; 20. static contact leading-out terminal; 30. connector; 31. first end of connector; 32. second end of connector; 40. first magnetizer; 41. perforation; 50. push rod assembly; 51. push rod; 52. support seat; 521. base; 522. bracket; 523. top portion; 524. lateral portion; 525. opening; 53. movable contact assembly; 54. movable contact piece; 55. third magnetizer; 56. elastic member; 60. second magnetizer; 610. first magnetizer piece; 620. second magnetizer piece; 1100. housing; 1110. first housing; 1120. second housing; 1130. exposing hole; 1200. electromagnetic unit; 1210. coil bobbin; 1220. coil; 1240. movable iron core; 1250. reset member; 1300. arc extinguishing unit; 1310. arc extinguishing magnet; 1320. yoke clamp; 1400. sealing unit; 1410. metal cover; D1. motion direction; D2. length direction.

### DETAILED DESCRIPTION

Exemplary embodiments will be now described more fully with reference to the accompanying drawings. However, the exemplary embodiments may be embodied in a variety of forms and should not be construed as is limited to the embodiments set forth herein. Although relative terms such as “above” and “under” are used herein to describe the relationship of one component relative to another component, such terms are used herein only for the sake of convenience, for example, in the directions shown in the figures. It can be understood that if the referenced device is inversed upside down, a component described as “above” will become a component described as “under”. Other relative terms such as “top” and “bottom” also have similar meanings. When a structure is described as “above” another structure, it probably means that the structure is integrally formed on another structure, or the structure is “directly” disposed on another structure, or the structure is “indirectly” disposed on another structure through an additional structure.

Words “one”, “a/an”, “the” and “said” are used herein to indicate the presence of one or more elements/component parts/and others. Terms “including” and “having” have an inclusive meaning which means that there may be additional elements/component parts/and others in addition to the listed elements/component parts/and others. Terms such as “first” and “second” are used herein only as markers and do not limit the number of objects modified after them.

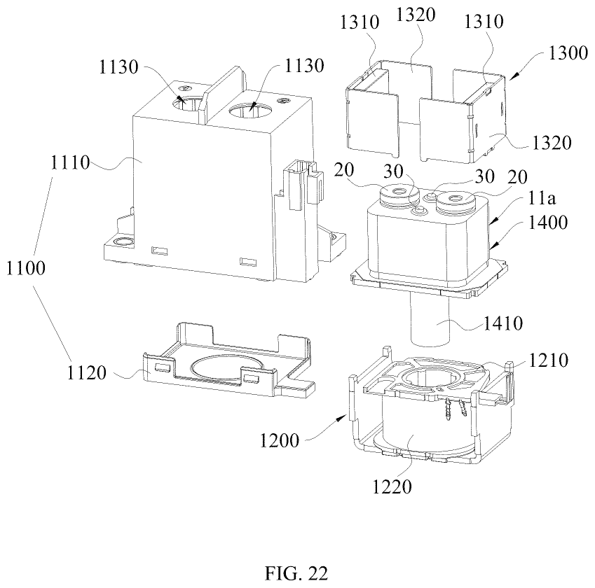

As shown in FIG. 22, it is a schematic exploded view of a relay according to embodiments of the present disclosure. The relay includes a housing 1100, an electromagnet unit 1200, an arc extinguishing unit 1300, and a sealing unit 1400. The sealing unit 1400 is disposed within the housing 1100, and a top of a static contact leading-out terminal 20 of the sealing unit 1400 is exposed on an outer surface of the housing 1100 through an exposing hole 1130 of the housing 1100. The electromagnetic unit 1200 and the arc extinguishing unit 1300 are both mounted within the housing 1100.

As an example, the housing 1100 includes a first housing 1110 and a second housing 1120, the first housing 1110 and the second housing 1120 snap together to form a chamber for accommodating the electromagnet unit 1200, the arc extinguishing unit 1300, and the sealing unit 1400.

The arc extinguishing unit 1300 is used to extinguish an arc generated between the static contact leading-out terminal 20 of the sealing unit 1400 and a movable contact piece 54.

As an example, the arc extinguishing unit 1300 includes two arc extinguishing magnets 1310. The arc extinguishing magnets 1310 may be permanent magnets, and each arc extinguishing magnet 1310 may be substantially rectangular prisms in shape. The two arc extinguishing magnets 1310 are respectively disposed at both sides of the sealing unit 1400 and are disposed opposite each other along a length direction D2 of the movable contact piece 54.

By providing two opposite arc extinguishing magnets 1310, a magnetic field may be formed around the static contact leading-out terminal 20 and the movable contact piece 54. Therefore, the arc generated between the static contact leading-out terminal 20 and the movable contact piece 54 will be elongated in a direction away from each other under the action of the magnetic field, achieving arc extinction.

The arc extinguishing unit 1300 also includes two yoke clamps 1320 disposed corresponding to positions of the two arc extinguishing magnets 1310. Moreover, the two yoke clamps 1320 surround the sealing unit 1400 and the two arc extinguishing magnets 1310. With the design of the yoke clamps 1320 surrounding the arc extinguishing magnets 1310, the magnetic field generated by the arc extinguishing magnets 1310 can be prevented from spreading outwards and affecting an arc extinguishing effect. Each yoke clamp 1320 is made of a soft magnetic material, which may include but is not limited to iron, cobalt, nickel, and alloys thereof.

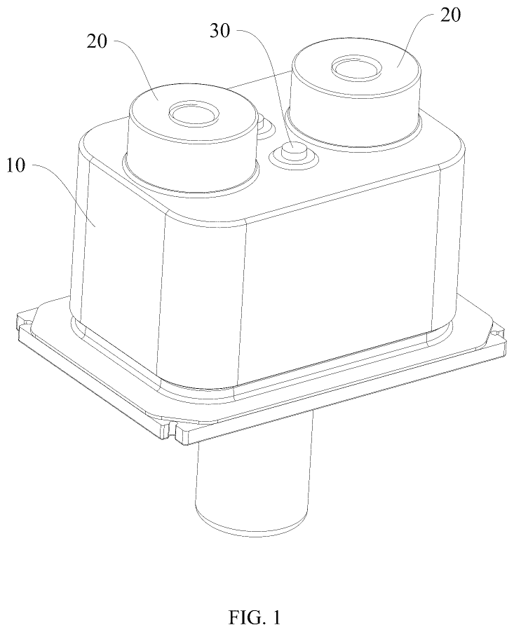

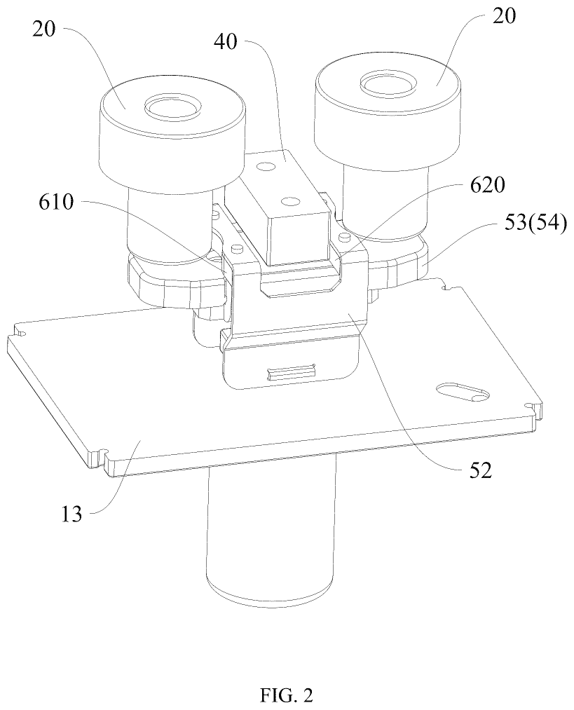

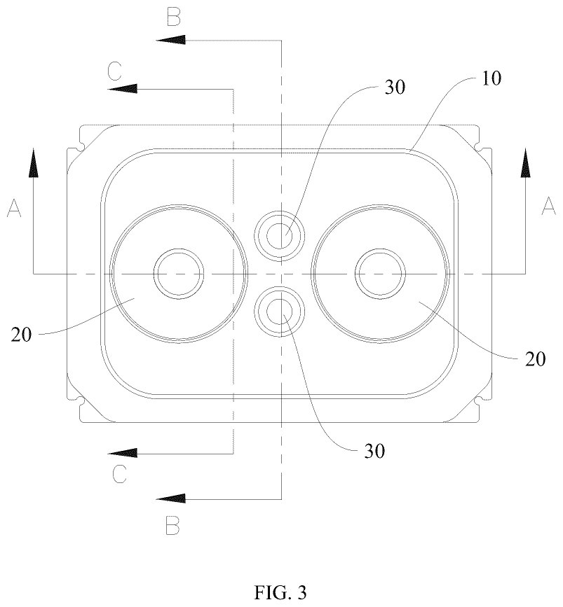

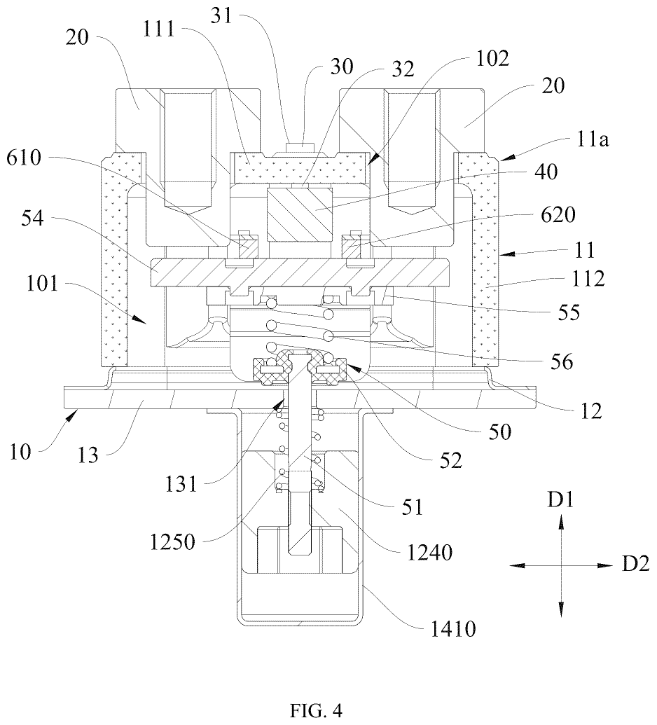

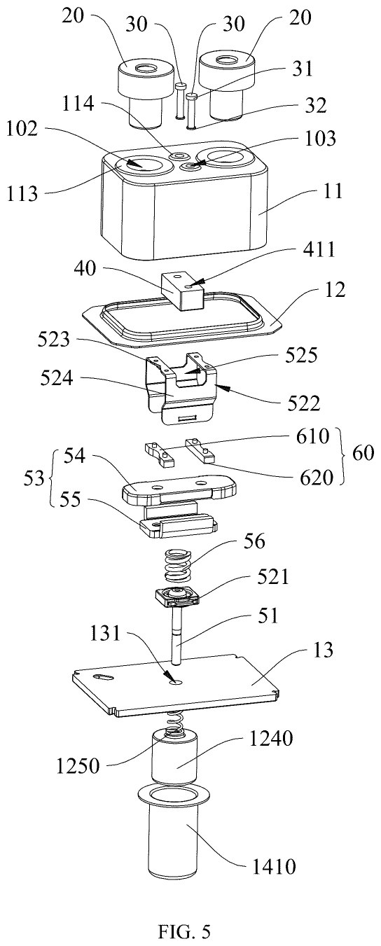

As shown in FIGS. 1 to 5, FIG. 1 is a schematic perspective view of a relay according to a first embodiment of the present disclosure; FIG. 2 is a schematic view of FIG. 1 with a ceramic cover 11 and a frame 12 removed; FIG. 3 is a schematic top view of FIG. 1; FIG. 4 is a sectional view along A-A in FIG. 3; and FIG. 5 shows a schematic exploded view of FIG. 1.

The sealing unit 1400 according to embodiments of the present disclosure includes a contact container 10, a pair of static contact leading-out terminals 20, a first magnetizer 40, a push rod assembly 50, a movable contact assembly 53, and an elastic member 56.

It can be understood that terms “including” and “having” as well as any variations thereof in embodiments of the present disclosure are intended to cover non-exclusive inclusions. For example, a process, method, system, product, or device that includes a series of steps or units is not limited to the listed steps or units, but may optionally include steps or units that are not listed, or may optionally include other steps or components inherent to the process, method, product, or device.

The contact container 10 has a contact chamber 101 therein. The contact container 10 may include an insulating cover 11a and a yoke plate 13. The insulating cover 11a covers a side surface of the yoke plate 13, and the insulating cover 11a and the yoke plate 13 together enclose the contact chamber 101.

The insulating cover 11a includes the ceramic cover 11 and the frame 12. The ceramic cover 11 is connected to the yoke plate 13 through the frame 12. The frame 12 may be a metal piece with a ring-shaped structure, such as an iron-nickel alloy, and one end of the frame 12 is connected to an open edge of the ceramic cover 11, for example, by laser welding, brazing, resistance welding, and gluing. The other end of the frame 12 is connected to the yoke plate 13, which may also be achieved by laser welding, brazing, resistance welding, and gluing. The frame 12 is disposed between the ceramic cover 11 and the yoke plate 13 to facilitate the connection between the ceramic cover 11 and the yoke plate 13.

The ceramic cover 11 includes a top wall 111 and a side wall 112; one end of the side wall 112 is connected to a periphery of the top wall 111, while the other end of the side wall 112 is connected to the yoke plate 13 through the frame 12. In this embodiment, the other end of the side wall 112 is connected to the yoke plate 13 through the frame 12.

The contact container 10 also has a pair of first through-holes 102 and a second through-hole 103; and the first through-holes 102 and the second through-hole 103 are in communication with the contact chamber 101. The first through-holes 102 are used to allow the static contact leading-out terminal 20 to pass through, and the second through-hole 103 is used to allow a connector 30 to pass through.

As an example, the first through-holes 102 and the second through-hole 103 are opened on the top wall 111 of the ceramic cover 11. The second through-hole 103 may be located between two first through-holes 102, that is, the connector 30 is disposed between a pair of static contact leading-out terminals 20.

There may be but not limited to two second through-holes 103 used to allow two connectors 30 to pass through.

One pair of static contact leading-out terminals 20 are connected to the contact container 10, and each static contact leading-out terminal 20 is at least partially located within the contact chamber 101. One of the pair of static contact leading-out terminals 20 serves as a terminal for current inflow, while the other thereof serves as a terminal for current outflow.

One pair of static contact leading-out terminals 20 pass through one pair of first through-holes 102 in one-to-one correspondence and are connected to the top wall 111 of the ceramic cover 11, for example, by welding.

A bottom of each static contact leading-out terminal 20 serves as a static contact, and the static contact may be integrally or separately disposed at the bottom of the static contact leading-out terminal 20.

The first magnetizer 40 is within the contact chamber 101 and is fixedly disposed relative to the contact container 10.

The push rod assembly 50 is connected to the contact container 10 in a movable manner along a motion direction D1. The push rod assembly 50 includes a push rod 51, a support seat 52, and a second magnetizer 60. The push rod 51 is movable relative to the contact container 10 along an axial direction of the push rod 51 (i.e., along the motion direction D1). The support seat 52 is fixedly disposed at one end of the push rod 51 along the axial direction, and at least partially extends into the contact chamber 101. The second magnetizer 60 is fixedly connected to the support seat 52 and is offset from the first magnetizer 40 along the axial direction of the push rod 51.

It should be noted that along the axial direction of the push rod 51, the second magnetizer 60 is offset from the first magnetizer 40, which may be understood as: along the axial direction of the push rod 51, an orthographic projection of the second magnetizer 60 on the movable contact piece does not overlap with an orthographic projection of the first magnetizer 40 on the movable contact piece.

As an example, the second magnetizer 60 may be fixed to the support seat 52 by riveting, but not limited thereto.

The yoke plate 13 has a third through-hole 131 that runs through two opposite sides of the yoke plate 13 along a thickness direction of the yoke plate 13, and the third through-hole 131 is in communication with the contact chamber 101 of the contact container 10. The push rod 51 passes through the third through-hole 131 in a movable manner along the axial direction.

Certainly, in other embodiments, the push rod assembly 50 may also be other structures, which will not be listed one by one here.

The movable contact assembly 53 is movable relative to the push rod assembly 50 along the axial direction of the push rod 51 and between a first position close to the static contact leading-out terminal 20 and a second position away from the static contact leading-out terminal 20. The movable contact assembly 53 includes the movable contact piece 54 and a third magnetizer 55. The first magnetizer 40 and the second magnetizer 60 are disposed at a side of the movable contact piece 54 facing the static contact leading-out terminal 20. Along the axial direction of the push rod 51, the third magnetizer 55 is fixedly disposed at a side of the movable contact piece 54 facing away from the first magnetizer 40 and the second magnetizer 60. That is, along a thickness direction of the movable contact piece 54 (i.e., along the motion direction D1), the first magnetizer 40 and the second magnetizer 60 are at one side of the movable contact piece 54, and the third magnetizer 55 is at the other side of the movable contact piece 54.

It should be noted that the movable contact assembly 53 is movable relative to the push rod assembly 50 along the axial direction of the push rod 51 between the first position and the second position, in which the “first position” and the “second position” refer to relative positions of the movable contact assembly 53 and the push rod assembly 50.

Specifically, when the electromagnetic unit 1200 is energized, the electromagnetic unit 1200 may drive the push rod 51, the support seat 52, and the movable contact assembly 53 to move together towards a direction close to the static contact leading-out terminal 20. When the movable contact assembly 53 comes into contact with the static contact leading-out terminal 20, the movable contact assembly 53 is stopped by the static contact leading-out terminal 20, while the push rod 51 and the support seat 52 continue to move upwards until an overtravel process is completed. During the overtravel process, relative movement is generated between the movable contact assembly 53 and the push rod assembly 50.

If the movable contact assembly 53 is defined to be stationary during the overtravel process, the push rod assembly 50 moves upwards relative to the movable contact assembly 53. If the push rod assembly 50 is defined to be stationary during the overtravel process, the movable contact assembly 53 moves downwards relative to the push rod assembly 50.

When the movable contact assembly 53 separates from the static contact leading-out terminal 20 or just comes into contact with the static contact leading-out terminal 20, the movable contact assembly 53 is in the first position relative to the push rod assembly 50, that is, the movable contact assembly 53 is close to the static contact leading-out terminal 20 relative to the push rod assembly 50. During the overtravel process, the movable contact assembly 53 moves downwards relative to the push rod assembly 50, that is, the movable contact assembly 53 moves in a direction away from the static contact leading-out terminal 20 relative to the push rod assembly 50, until the movable contact assembly 53 moves to the second position relative to the push rod assembly 50. When the movable contact assembly 53 moves to the second position relative to the push rod assembly 50, the overtravel is completed. At this time, the compression of the elastic member 56 is at its maximum value.

As can be seen, when the movable contact assembly 53 is in the first position relative to the push rod assembly 50, it may be considered that the movable contact assembly 53 separates from the static contact leading-out terminal 20 or just comes into contact with the static contact leading-out terminal 20; when the movable contact assembly 53 is in the second position relative to the push rod assembly 50, the overtravel is completed.

As an example, the third magnetizer 55 and the movable contact piece 54 may be fixed together by riveting, but not limited thereto.

It can be understood that the first magnetizer 40, the second magnetizer 60, and the third magnetizer 55 may all be made of materials such as iron, cobalt, nickel, and alloys thereof.

In one embodiment, the first magnetizer 40 and the second magnetizer 60 may be linear in shape, and the third magnetizer 55 may be U-shaped, but not limited thereto.

It can be understood that the first magnetizer 40, the second magnetizer 60, and the third magnetizer 55 may all be designed to include a plurality of stacked magnetic conductive sheets as needed.

Two ends of the movable contact piece 54 are used to make contact with bottoms of one pair of static contact leading-out terminals 20, to achieve contact closure. The two ends of the movable contact piece 54 along its length direction D2 may serve as movable contacts. The movable contacts at the two ends of the movable contact piece 54 may protrude from other parts of the movable contact piece 54 or be flush with other parts.

It can be understood that the movable contacts may be integrally or separately disposed at both ends of the movable contact piece 54 along its length direction D2.

The elastic member 56 is disposed between the movable contact assembly 53 and the support seat 52, and is used to apply an elastic force to the movable contact assembly 53 to move towards the first position.

As an example, the elastic member 56 may be a spring, but is not limited thereto.

In one embodiment, one end of the elastic member 56 abuts against the support seat 52, and the other end thereof abuts against the third magnetizer 55 of the movable contact assembly 53.

Certainly, in other embodiments, the third magnetizer 55 may also be provided with a through-hole, and the elastic member 56 may pass through the through-hole to abut against the movable contact piece 54.

The support seat 52 includes a base 521 and a bracket 522. The base 521 is connected to an end of the push rod 51 along the axial direction, and the bracket 522 is connected to the base 521. The second magnetizer 60 is connected to an inner wall surface of the bracket 522, and the movable contact piece 54 and the third magnetizer 55 are movably disposed between the base 521 and the bracket 522. One end of the elastic member 56 abuts against the base 521, and the other end thereof abuts against the third magnetizer 55.

In one embodiment, the bracket 522 may be in an inverted U-shape and be snap-fit with the base 521. The base 521 and the bracket 522 enclose a chamber that is used to accommodate the movable contact assembly 53 and the elastic member 56.

The bracket 522 may include a top portion 523 and two lateral portions 524, and the two lateral portions 524 are respectively connected to both sides of the top portion 523 and extend from the top portion 523 towards the base 521, forming the inverted U-shape of the bracket 522. An end, away from the top portion 523, of each of the two lateral portions 524 is connected to the base 521. A space is formed between the two lateral portions 524 to allow the movable contact piece 54 and the third magnetizer 55 to pass through and move.

The second magnetizer 60 is connected to an inner wall surface of the top portion 523. In a state where the movable contact piece 54 is not in contact with the static contact leading-out terminal 20 or just comes into contact with the static contact leading-out terminal 20, under the elastic force of the elastic member 56, the movable contact piece 54 abuts against the second magnetizer 60. During the overtravel process, the static contact leading-out terminal 20 stops the movable contact assembly 53 (the movable contact piece 54 and the third magnetizer 55), and keeps the movable contact assembly 53 stationary, while the push rod 51 drives the support seat 52 and the second magnetizer 60 to continue moving upward, at which time the movable contact assembly 53 and the base 521 jointly press the elastic member 56.

It can be understood that in other embodiments, the second magnetizer 60 may not be fixedly connected to the bracket 522 of the support seat 52, but may be fixedly connected to one end of the push rod 51. Specifically, the movable contact assembly 53 may be provided with a through-hole, and the push rod 51 passes through the through-hole of the movable contact assembly 53; the second magnetizer 60 is disposed at one end of the push rod 51.

The sealing unit 1400 also includes a metal cover 1410, and the metal cover 1410 is connected to a side of the yoke plate 13 facing away from the insulating cover 11a and covers the third through-hole 131 in the yoke plate 13. The metal cover 1410 and the yoke plate 13 enclose a chamber for accommodating a static iron core and a movable iron core 1240 of the electromagnet unit 1200, which will be described in detail below.

As shown in FIGS. 4 and 22, the electromagnetic unit 1200 includes a coil bobbin 1210, a coil 1220, the static iron core (not shown in the figures), the movable iron core 1240, and a reset member 1250. The coil bobbin 1210 is in the shape of a hollow cylinder and is made of an insulating material. The metal cover 1410 passes through the coil bobbin 1210. The coil 1220 surrounds the coil bobbin 1210. The static iron core is fixed inside the metal cover 1410, and some of the static iron core extends into the third through-hole 131. The static iron core has a perforation disposed corresponding to the position of the third through-hole 131, to allow the push rod 51 to pass through. The movable iron core 1240 is movably disposed inside the metal cover 1410 and is opposite to the static iron core. The movable iron core 1240 is connected to the push rod 51 and is used to be attracted by the static iron core when the coil 1220 is energized. The movable iron core 1240 and the push rod 51 may be connected by screwing, riveting, welding, or other means.

The reset member 1250 is located inside the metal cover 1410 and disposed between the static iron core and the movable iron core 1240. The reset member 1250 is used to reset the movable iron core 1240 when the coil 1220 is de-energized. The reset member 1250 may be a spring and fitted over the push rod 51.

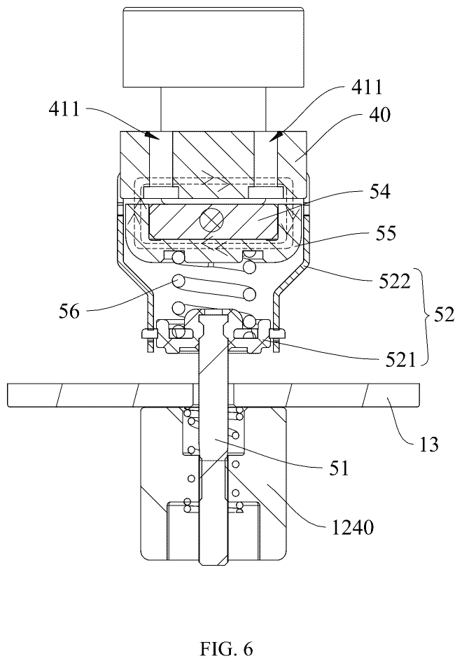

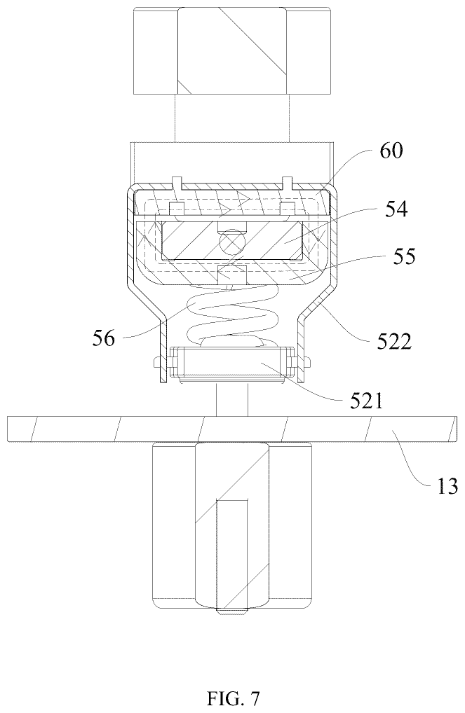

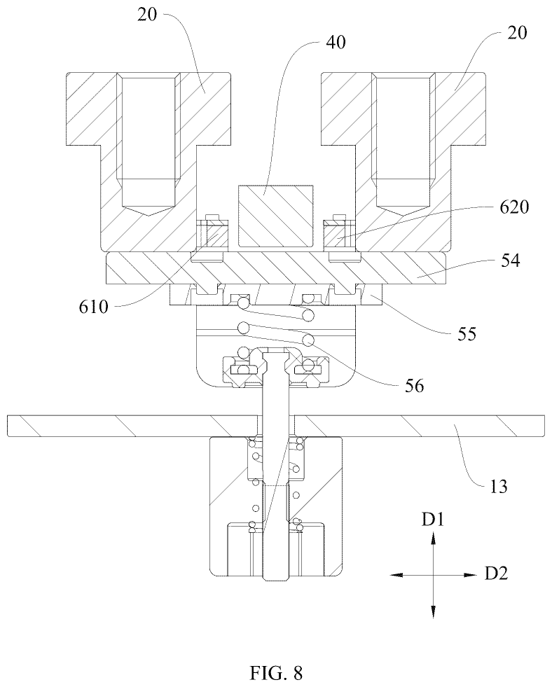

As shown in FIGS. 6 to 8, FIG. 6 is a sectional view along B-B in FIG. 3, where the ceramic cover, the frame, and the connector are omitted and the overtravel has been completed; FIG. 7 is a sectional view along C-C in FIG. 3, where the ceramic cover, the frame, and the connector are omitted and the overtravel has been completed; FIG. 8 is a sectional view along A-A in FIG. 3, where the ceramic cover, the frame, and the connector are omitted and the overtravel has been completed.

It should be noted that FIGS. 6 to 8 show a state when the overtravel has been completed. In this state, the movable contact assembly 53 may be considered to be in the second position relative to the push rod assembly 50.

As shown in FIGS. 6 and 7, a first magnetic circuit is formed between the first magnetizer 40 and the third magnetizer 55, thereby generating a magnetic attraction force between the first magnetizer 40 and the third magnetizer 55; a second magnetic circuit is formed between the second magnetizer 60 and the third magnetizer 55, thereby generating a magnetic attraction force between the second magnetizer 60 and the third magnetizer 55. Since the first magnetizer 40 is fixedly disposed relative to the contact container 10, a fixed anti-short circuit structure is formed between the first magnetizer 40 and the third magnetizer 55 when a short-circuit current is applied, and a retaining force for the fixed anti-short circuit structure is provided by the contact container 10. Since the second magnetizer 60 is fixedly connected to the support seat 52 of the push rod assembly 50, a follower anti-short circuit structure is formed between the second magnetizer 60 and the third magnetizer 55 when a short-circuit current is applied, and a retaining force for the follower anti-short circuit structure is provided by the coil 1220 of the relay. On the premise of constant drive of the coil 1220, dual anti-short circuit structures of embodiments of the present disclosure effectively improve an upper limit of the anti-short circuit current carrying ability.

In addition, as shown in FIG. 8, along the axial direction of the push rod 51, the second magnetizer 60 is offset from the first magnetizer 40, so that the first magnetic circuit formed between the first magnetizer 40 and the third magnetizer 55 does not interfere with the second magnetic circuit formed between the second magnetizer 60 and the third magnetizer 55, and hence the magnetic attraction force of the first magnetizer 40 and the magnetic attraction force of the second magnetizer 60 will not interfere with each other, ensuring an anti-short circuit effect. In addition, compared to a technical solution where magnetizers are disposed overlappingly, the first magnetizer 40 and the second magnetizer 60 in embodiments of the present disclosure are offset, so that the magnetic attraction forces do not interfere with each other, and then on the premise of resisting the same magnitude of electro-dynamic repulsion force, the thickness of the first magnetizer 40 may be reduced, which not only lowers the cost but also reduces the volume of the relay.

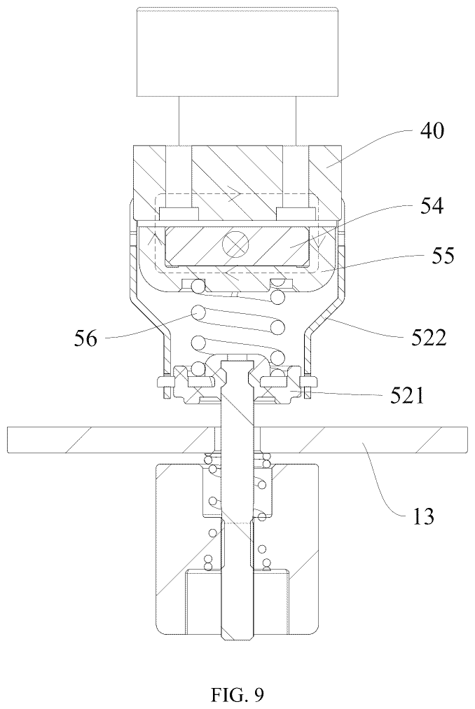

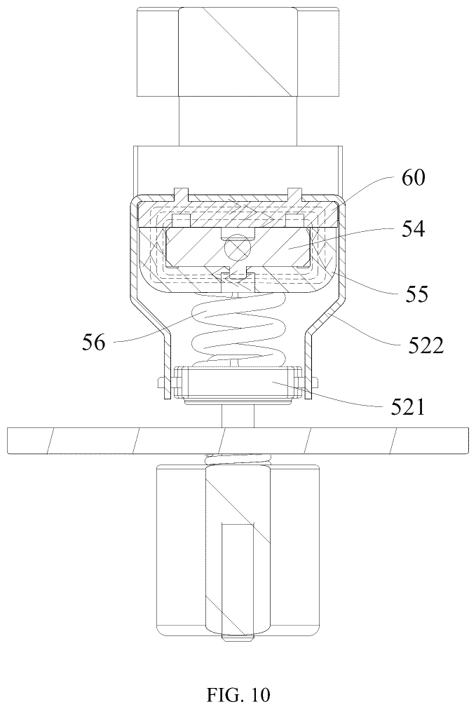

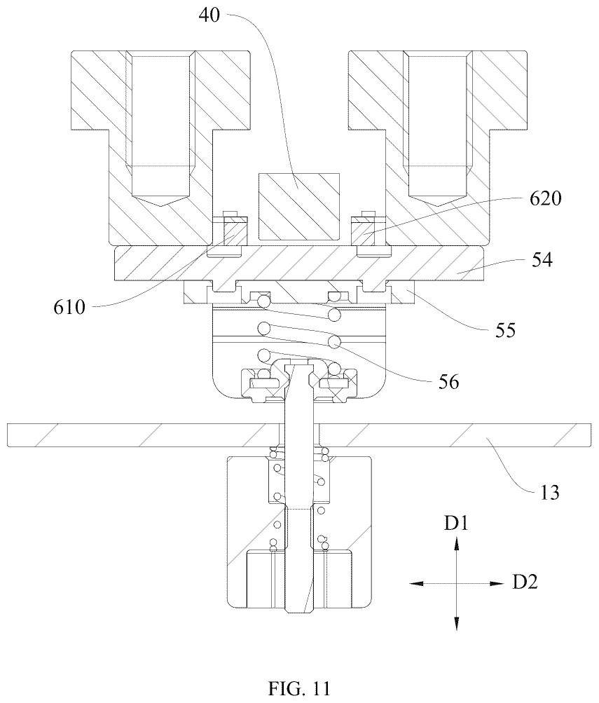

As shown in FIGS. 9 to 11, FIG. 9 is a sectional view along B-B in FIG. 3, where the ceramic cover, the frame, and the connector are omitted, and the movable contact piece 54 just comes into contact with or separates from the static contact leading-out terminal 20; FIG. 10 is a sectional view along C-C in FIG. 3, where the ceramic cover, the frame, and the connector are omitted, and the movable contact piece 54 just comes into contact with or separates from the static contact leading-out terminal 20; FIG. 11 is a sectional view along A-A in FIG. 3, where the ceramic cover, the frame, and the connector are omitted, and the movable contact piece 54 just comes into contact with or separates from the static contact leading-out terminal 20.

It should be noted that FIGS. 9 to 11 show a state when the movable contact piece 54 just comes into contact with or just separates from the static contact leading-out terminal 20. In this state, the movable contact assembly 53 may be considered to be in the first position relative to the push rod assembly 50.

For the convenience of illustrating the effect of the relay of the present disclosure in satisfying an overload current breaking requirement while improving the anti-short circuit ability, FIGS. 9 to 11 show, as an example, a state when the movable contact piece 54 just separates from the static contact leading-out terminal 20.

When the coil 1220 of the relay is de-energized, under the action of the movable iron core 1240 of the relay, the push rod assembly 50 moves downwards relative to the static contact leading-out terminal 20, which is equivalent to the movable contact assembly 53 moving from the second position to the first position relative to the push rod assembly 50, i.e., switching from FIG. 7 to FIG. 10. During the movement of the movable contact assembly 53 from the second position to the first position, a magnetic gap between the second magnetizer 60 and the third magnetizer 55 gradually decreases. When the movable contact assembly 53 moves to the first position, the second magnetizer 60 comes into contact with the movable contact assembly 53, in which case the magnetic gap between the second magnetizer 60 and the third magnetizer 55 is smaller than a magnetic gap between the first magnetizer 40 and the third magnetizer 55.

It can be understood that most of magnetic flux will flow towards a magnetic circuit with a smaller magnetic gap, that is, most of the magnetic flux will flow towards the magnetic circuit formed by the second magnetizer 60 and the third magnetizer 55. For example, as shown in FIG. 9, a magnetic induction line is formed between the first magnetizer 40 and the third magnetizer 55. As shown in FIG. 10, three magnetic induction lines are formed between the second magnetizer 60 and the third magnetizer 55.

At this point, the magnetic attraction force between the second magnetizer 60 and the third magnetizer 55 is larger, while the magnetic attraction force between the first magnetizer 40 and the third magnetizer 55 is smaller. Since the second magnetizer 60 is in contact with the movable contact assembly 53, the magnetic attraction force between the second magnetizer 60 and the third magnetizer 55 becomes an internal force, which will not affect the breaking of the movable contact piece 54. Therefore, the movable contact piece 54 only needs to overcome the smaller magnetic attraction force between the first magnetizer 40 and the third magnetizer 55 to achieve breaking.

In addition, as mentioned above, the first magnetizer 40 and the second magnetizer 60 according to embodiments of the present disclosure are offset, and the magnetic attraction force between the two will not cancel out, which may reduce the thickness of the first magnetizer 40. Further, as the thickness of the first magnetizer 40 decreases, the magnetic attraction force generated between the first magnetizer 40 and the third magnetizer 55 also decreases. During a limit breaking process, when the second magnetizer 60 comes into contact with the movable contact piece 54 and the magnetic attraction force between the second magnetizer 60 and the third magnetizer 55 becomes the internal force, the magnetic attraction force of the first magnetizer 40 that the movable contact piece 54 needs to resist is also reduced, which is more conducive to achieving breaking.

As can be seen, the first magnetizer 40 is fixedly disposed relative to the contact container 10, and the fixed anti-short circuit structure is formed between the first magnetizer 40 and the third magnetizer 55; the second magnetizer 60 is fixedly connected to the support seat 52 of the push rod assembly 50, and the follower anti-short circuit structure is formed between the second magnetizer 60 and the third magnetizer 55; the first magnetizer 40 and the second magnetizer 60 are offset along the axial direction of the push rod 51, so that the relay of embodiments of the present disclosure not only meets the requirements of anti-short circuit and limit breaking, but also has advantages of reducing the cost and the volume of the relay.

It can be understood that when the movable contact assembly 53 is in the first position relative to the push rod assembly 50, there may be direct contact or a gap between the second magnetizer 60 and the third magnetizer 55.

In this embodiment, the movable contact assembly 53 is in the first position relative to the push rod assembly 50, and the second magnetizer 60 is in direct contact with the third magnetizer 55. In this way, a larger portion of the magnetic flux will flow towards the magnetic circuit formed by the second magnetizer 60 and the third magnetizer 55, while a smaller portion of the magnetic flux will flow towards the magnetic circuit formed by the first magnetizer 40 and the third magnetizer 55. The magnetic attraction force between the first magnetizer 40 and the third magnetizer 55 is smaller, which is more conducive to the breaking of the movable contact piece 54 and the static contact leading-out terminal 20.

As shown in FIGS. 5, 8, and 11, the second magnetizer 60 includes a first magnetizer piece 610 and a second magnetizer piece 620. The first magnetizer piece 610 and the second magnetizer piece 620 are disposed side by side along the length direction D2 of the movable contact piece 54 and are respectively located at two opposite sides of the first magnetizer 40.

The bracket 522 has an opening 525, which is used to avoid the first magnetizer 40 when the support seat 52 moves relative to the contact container 10.

As an example, the opening 525 is formed at the top portion 523 of the bracket 522 and at the connection between the lateral portions 524 and the top portion 523.

As shown in FIGS. 4 and 5, the relay according to embodiments of the present disclosure further includes the connector 30, which passes through the second through-hole 103. The connector 30 includes a first end 31 and a second end 32, with the first end 31 connected to the contact container 10 and the second end 32 connected to the first magnetizer 40.

In the relay according to embodiments of the present disclosure, the first magnetizer 40 is connected to the contact container 10 through the connector 30, rather than directly connected to the contact container 10, which makes the connection process unobstructed and visualized and which is convenient to operate and ensures the connection reliability.

In an embodiment, the first magnetizer 40 has a connecting hole 411, and the connector 30 passes through the connecting hole 411.

Further, the first through-hole 102 and the second through-hole 103 are opened on the top wall 111 of the ceramic cover 11, and the first end 31 of the connector 30 is connected to an outer wall surface of the top wall 111.

In the outer wall surface of the top wall 111, a first metallization layer 113 is provided at a periphery of the first through-hole 102, and a second metallization layer 114 is provided at a periphery of the second through-hole 103. The static contact leading-out terminal 20 is welded to the top wall 111 through the first metallization layer 113, and the first end 31 of the connector 30 is welded to the top wall 111 through the second metallization layer 114.

Compared to an inner wall surface of the ceramic cover 11, the outer wall surface of the top wall 111 of the ceramic cover 11 is more likely to form a welding plane. Moreover, since the top wall 111 of the ceramic cover 11 needs to be provided with the static contact leading-out terminal 20, and the metallization layer also needs to be provided at the periphery of the first through-hole 102 when the static contact leading-out terminal 20 is welded to the top wall 111, the second metallization layer 114 for the second through-hole 103 is also processed together with the processing of the first metallization layer 113 for the first through-hole 102. Therefore, by welding the connector 30 to the outer wall surface of the top wall 111 of the ceramic cover 11, the metallization layer may be processed only on the outer wall surface of the top wall 111, without the need to process the metallization layer on the inner wall surface of the top wall 111, which facilitates processing and simplifies the processing steps.

The first magnetizer 40 is spaced apart from the inner wall surface of the top wall 111. Since the first magnetizer 40 and the inner wall surface of the top wall 111 are spaced apart, there is a gap between the first magnetizer 40 and the inner wall surface of the top wall 111. Since the first magnetizer 40 is not in direct contact with the inner wall surface of the top wall 111, the arrangement of the first magnetizer 40 does not affect a creepage distance of one pair of static contact leading-out terminals 20.

The top wall 111 and the side wall 112 are of a separate structure and are connected by welding.

It can be understood that by designing the ceramic cover 11 as the separate structure of the top wall 111 and the side wall 112, it is more convenient to connect the connector 30 to the top wall 111. Certainly, the top wall 111 and the side wall 112 may also be bonded together.

Specifically, since the top wall 111 is sheet-like, the sheet-like structure makes it easier to process the first through-hole 102, the second through-hole 103, the first metallization layer 113, and the second metallization layer 114 on the top wall 111. Further, the sheet-like structure makes it easier to achieve welding between the connector 30 and the top wall 111, as well as between the static contact leading-out terminal 20 and the top wall 111.

Certainly, the top wall 111 and the side walls 112 may also be of an integral structure.

The connection between the second end 32 of the connector 30 and the first magnetizer 40 may be implemented in various ways, such as welding, riveting, gluing, etc.

Certainly, in other embodiments, the first magnetizer 40 is fixedly disposed relative to the contact container 10. In addition to be fixedly connected to the ceramic cover 11, the first magnetizer 40 may also be fixedly connected to a fixed frame. Specifically, the relay also includes a fixed frame, which is disposed in the contact chamber 101 and fixedly connected to the yoke plate 13. The first magnetizer 40 is fixedly connected to the fixed frame.

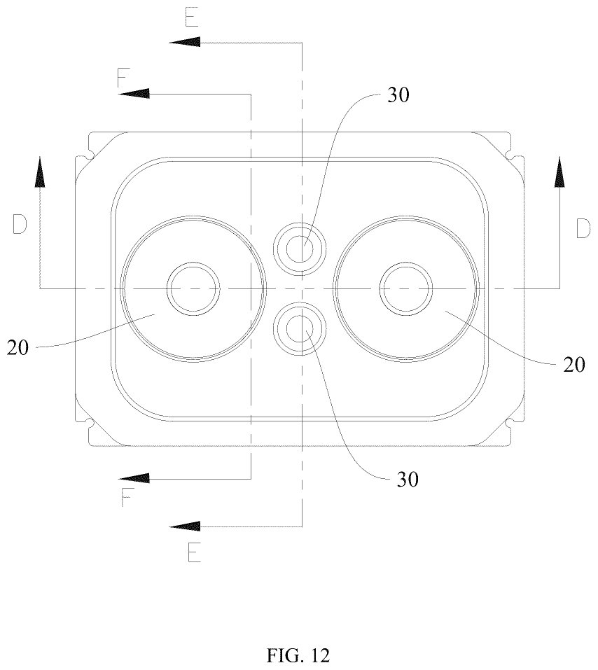

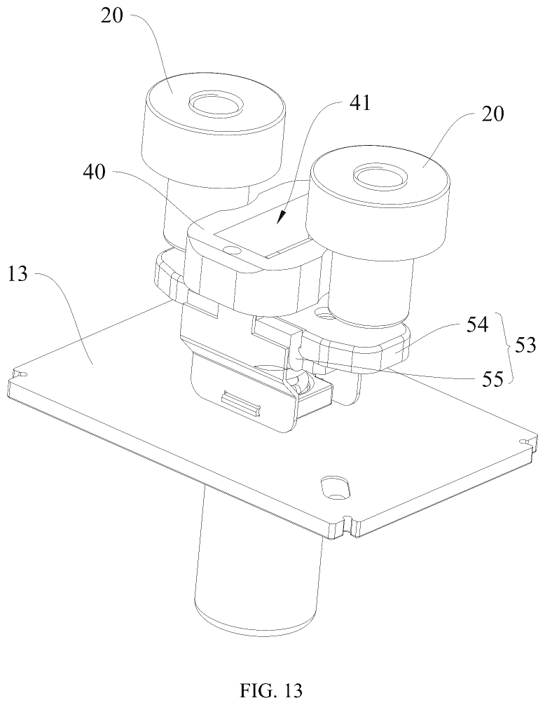

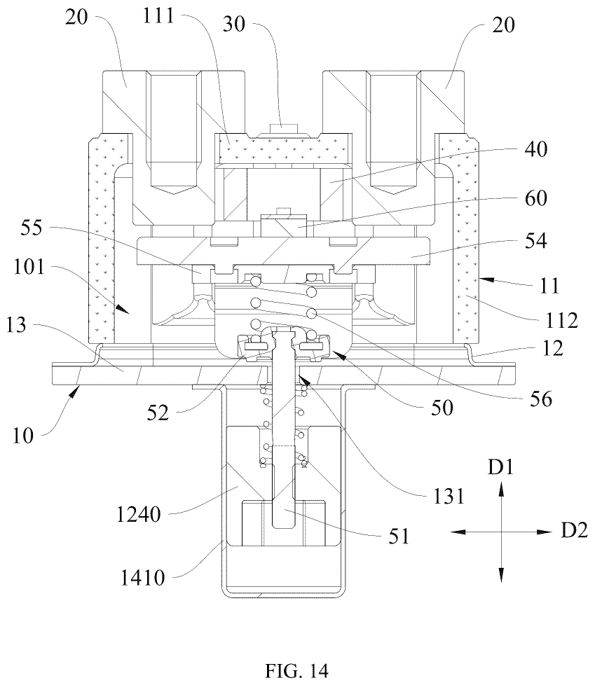

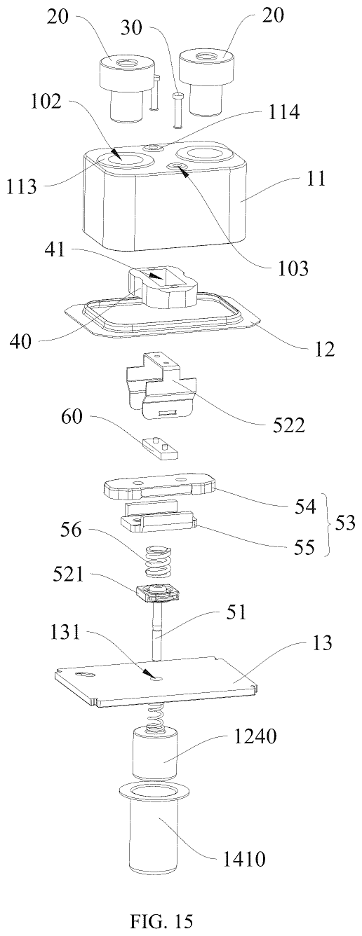

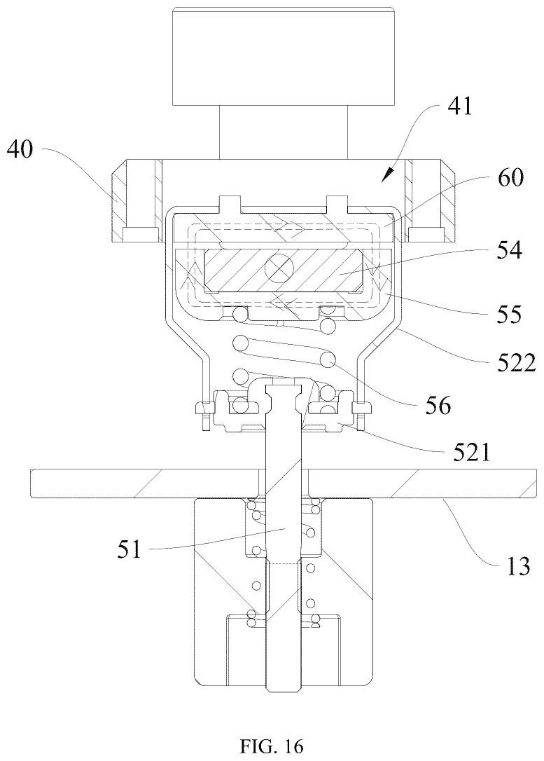

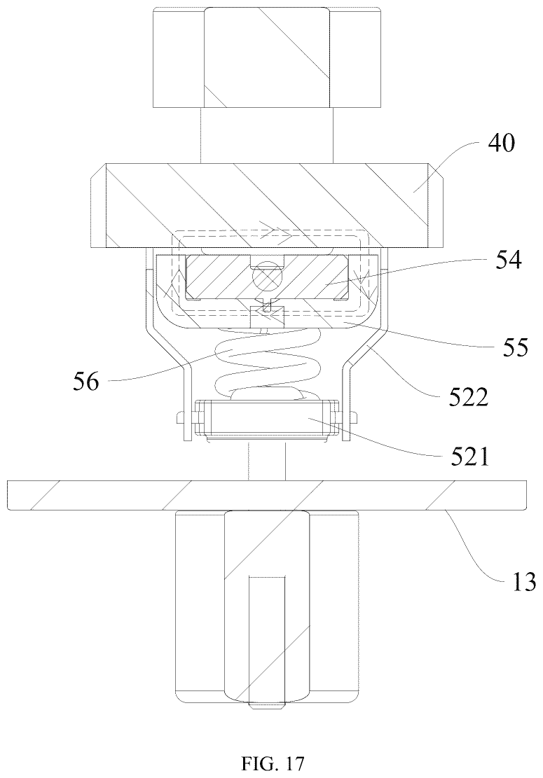

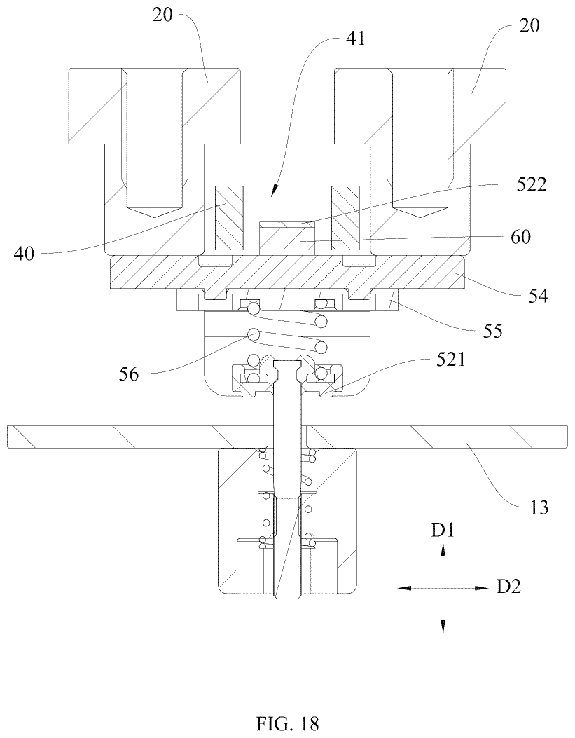

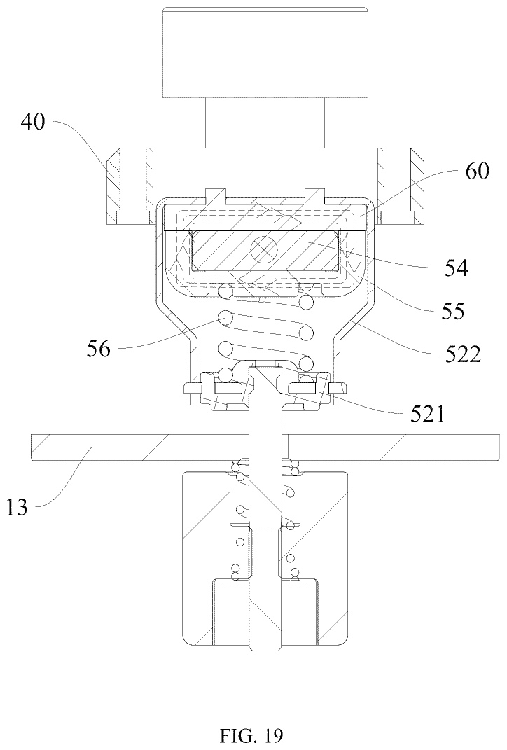

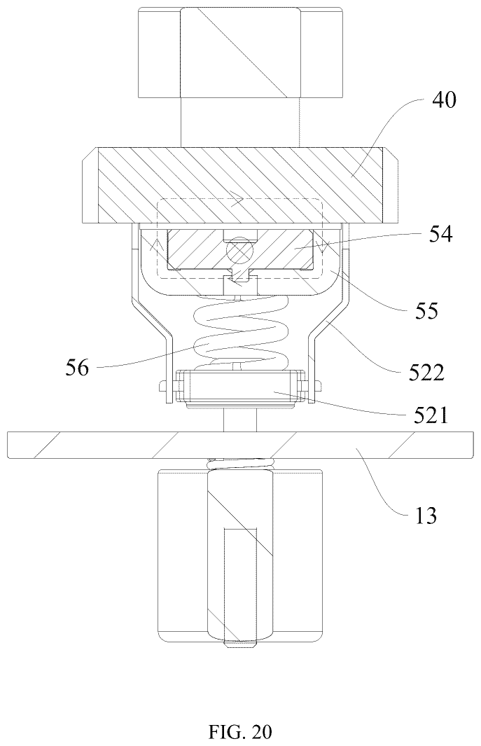

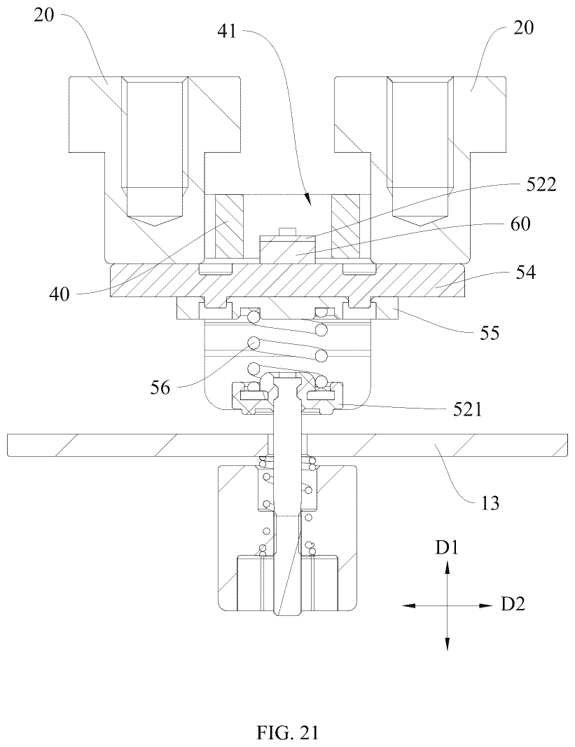

As shown in FIGS. 12 to 21, similarities between a second embodiment and the first embodiment will not be repeated, and differences of the second embodiment are as follows.

The first magnetizer 40 has a perforation 41 that runs through two opposite sides of the first magnetizer 40 along the axial direction of the push rod 51. Along the axial direction of the push rod 51, the second magnetizer 60 corresponds to the perforation 41.

It can be understood that various embodiments/implementations provided in this disclosure may be combined with each other without contradiction, which will not be elaborated herein.

One embodiment of the present disclosure has at least the following advantages or beneficial effects.

For the relay according to embodiments of the present disclosure, the first magnetizer is fixedly disposed relative to the contact container, and a fixed anti-short circuit structure is formed between the first magnetizer and the third magnetizer; a follower anti-short circuit structure is formed between the second magnetizer of the push rod assembly and the third magnetizer; the first magnetizer and the second magnetizer are offset along the axial direction of the push rod, so that the relay of embodiments of the present disclosure not only meets the requirements of anti-short circuit and limit breaking, but also has advantages of reducing the cost and the volume of the relay.

It should be understood that the application of the present disclosure is not limit to the detailed structure and arrangement of components provided in this specification. The present disclosure may have other embodiments, and may be implemented and carried out in various ways. The aforementioned variations and modifications fall within the scope of the present disclosure. It should be understood that the present disclosure revealed and defined in this specification may extend to all alternative combinations of two or more individual features that are apparent or mentioned in the text and/or drawings. All of the different combinations form various alternative aspects of the present disclosure. Embodiments described in this specification illustrate the best modes known for carrying out the present disclosure, and will allow those skilled in the art to utilize the present disclosure.

1. A relay, comprising:
a contact container having a contact chamber;
a pair of static contact leading-out terminals fixedly disposed relative to the contact container;
a first magnetizer provided in the contact chamber and fixedly disposed relative to the contact container;
a push rod assembly comprising a push rod and a second magnetizer, the push rod is movable along an axial direction of the push rod relative to the contact container, and the second magnetizer is disposed at an end of the push rod and offset from the first magnetizer in the axial direction of the push rod; and
a movable contact assembly movable relative to the push rod assembly along the axial direction of the push rod and between a first position close to the static contact leading-out terminal and a second position away from the static contact leading-out terminal, wherein the movable contact assembly comprises a movable contact piece and a third magnetizer; the first magnetizer and the second magnetizer are disposed at a side of the movable contact piece facing the static contact leading-out terminal; along the axial direction of the push rod, the third magnetizer is fixedly disposed at a side of the movable contact piece facing away from the first magnetizer and the second magnetizer; the third magnetizer and the first magnetizer are configured to form a first magnetic circuit, and the third magnetizer and the second magnetizer are configured to form a second magnetic circuit.

2. The relay according to claim 1, further comprising an elastic member connecting to the movable contact assembly and the push rod assembly and configured to apply an elastic force to the movable contact assembly to move towards the first position.

3. The relay according to claim 1, wherein in a state where the movable contact assembly is in the first position, a magnetic gap between the first magnetizer and the third magnetizer is greater than a magnetic gap between the second magnetizer and the third magnetizer.

4. The relay according to claim 3, wherein when the movable contact assembly is in the first position, the second magnetizer is in direct contact with the third magnetizer.

5. The relay according to claim 2, wherein the pushing push rod assembly further comprises a support seat fixedly disposed at an end of the push rod along the axial direction and at least partially extending into the contact chamber; the second magnetizer is fixedly connected to the support seat, and the elastic member is disposed between the movable contact assembly and the support seat.

6. The relay according to claim 5, wherein the support seat comprises:
a base connected to an end of the push rod, the elastic member is disposed between the base and the movable contact assembly; and
a bracket connected to the base, the second magnetizer is connected to an inner wall surface of the bracket, and the movable contact piece and the third magnetizer are movably disposed in a space enclosed by the base and the bracket.

7. The relay according to claim 6, wherein the bracket comprises:
a top portion, the second magnetizer is connected to an inner wall surface of the top portion; and
two lateral portions respectively connected to both sides of the top portion, wherein an end, away from the top portion, of each of the two lateral portions is connected to the base; and the two lateral portions, the top portion and the base together form a space for movement of the movable contact assembly.

8. The relay according to claim 1, wherein the first magnetizer has a perforation that runs through two opposite sides of the first magnetizer along the axial direction of the push rod, and a position of the second magnetizer corresponds to the perforation along the axial direction of the push rod.

9. The relay according to claim 1, wherein the second magnetizer comprises a first magnetizer piece and a second magnetizer piece;
the first magnetizer piece and the second magnetizer piece are disposed side by side along a length direction of the movable contact piece and are respectively located at two opposite sides of the first magnetizer.

10. The relay according to claim 1, wherein the contact container further has a pair of first through-holes and a second through-hole, the first through-holes and the second through-hole is in communication with the contact chamber, and a pair of static contact leading-out terminals pass through the pair of first through-holes in one-to-one correspondence;
the relay further comprises a connector passing through the second through-hole, the connector comprises a first end and a second end, the first end is connected to the contact container, and the second end is connected to the first magnetizer.

11. The relay according to claim 10, wherein the contact container comprises:
a yoke plate; and
an insulating cover, comprising a top wall and a side wall, wherein one end of the side wall is connected to a periphery of the top wall, while another end of the side wall is connected to the yoke plate,
wherein the first through-holes and the second through-hole are opened in the top wall, and the first end of the connector is connected to an outer wall surface of the top wall.

12. The relay according to claim 11, wherein the insulating cover comprises a ceramic cover and a frame, the ceramic cover comprises the top wall and the side wall, and another end of the side wall is connected to the yoke plate through the frame;
in the outer wall surface of the top wall, a first metallization layer is provided at a periphery of the first through-hole, and a second metallization layer is provided at a periphery of the second through-hole;
the static contact leading-out terminal is welded to the top wall through the first metallization layer, and the first end of the connector is welded to the top wall through the second metallization layer.

13. The relay according to claim 11, wherein the top wall and the side wall are of an integral structure; or the top wall and the side wall are of a separate structure.

14. The relay according to claim 11, wherein the first magnetizer is spaced apart from an inner wall surface of the top wall.

15. The relay according to claim 1, wherein the contact container comprises:
a yoke plate; and
an insulating cover connected to the yoke plate,
wherein the relay further comprises a fixed frame disposed in the contact chamber and fixedly connected to the yoke plate, the first magnetizer is fixedly disposed at the fixed frame.

16. The relay according to claim 1, wherein the pair of static contact terminals are connected to the contact container, at least a portion of each of the static contact terminals is located within the contact chamber.

17. The relay according to claim 10, wherein the first magnetizer has a connecting hole, and the connector passes through the connecting hole.

18. The relay according to claim 16, wherein the contact container further has a pair of first through-holes and a second through-hole, the first through-holes and the second through-hole is in communication with the contact chamber, and a pair of static contact leading-out terminals pass through the pair of first through-holes in one-to-one correspondence;
the relay further comprises a connector passing through the second through-hole, the connector comprises a first end and a second end, the first end is connected to the contact container, and the second end is connected to the first magnetizer.

19. The relay according to claim 2, wherein the contact container further has a pair of first through-holes and a second through-hole, the first through-holes and the second through-hole is in communication with the contact chamber, and a pair of static contact leading-out terminals pass through the pair of first through-holes in one-to-one correspondence;
the relay further comprises a connector passing through the second through-hole, the connector comprises a first end and a second end, the first end is connected to the contact container, and the second end is connected to the first magnetizer.

20. The relay according to claim 3, wherein the contact container further has a pair of first through-holes and a second through-hole, the first through-holes and the second through-hole is in communication with the contact chamber, and a pair of static contact leading-out terminals pass through the pair of first through-holes in one-to-one correspondence;
the relay further comprises a connector passing through the second through-hole, the connector comprises a first end and a second end, the first end is connected to the contact container, and the second end is connected to the first magnetizer.
